(19) United States
(12) Patent Application Publication
(10) Pub. No.: US 2016/0300289 A1
(43) Pub. Date: Oct. 13, 2016

(54) SYSTEMS AND METHODS FOR GENERATING CANNABIS STRAIN PREFERENCE PROFILES

(71) Applicant: Marmot Jaguar Corp., Shoreline, WA (US)

(72) Inventor: Lauren ROSE, Shoreline, WA (US)

(21) Appl. No.: 15/094,986

(22) Filed: Apr. 8, 2016

Related U.S. Application Data
(60) Provisional application No. 62/144,725, filed on Apr. 8, 2015.

(51) Int. Cl. G06Q 30/06

(52) U.S. Cl. CPC G06Q 30/0631; G06Q 30/0607

(57) ABSTRACT

Systems and methods for a privacy protected application to dynamically store information regarding users past cannabis experiences and to use that information, in conjunction with various characteristics inherent to individual cannabis strains from particular sources and instances to match up with or to follow other users and to find more preferable strains or sources of those strains or more preferable methods of ingesting the cannabis for that particular user.

### PRIORITY

This application claims priority to Provisional Patent App. No. 62/144,725 entitled “SYSTEMS AND METHODS FOR GENERATING CANNABIS STRAIN PREFERENCE PROFILES” and filed Apr. 8, 2015, under Attorney Docket No. ROLA-2015002, the entire disclosure of which is hereby incorporated by reference, for all purposes.

### FIELD

The present disclosure relates to cataloging various characteristics of cannabis strains, and more particularly, to systems and methods for generating cannabis strain preference profiles.

### BACKGROUND

Cannabis, otherwise known as marijuana (and numerous other names), is a preparation of plants from the cannabis genus generally intended for human consumption. Cannabis is often consumed for its psychoactive and physiological effects, which may include heightened mood or euphoria, relaxation, and an increase in appetite. Possible side-effects may include a decrease in short-term memory, dry mouth, impaired motor skills, reddening of the eyes, and feelings of paranoia or anxiety. Pharmacologically, tetrahydrocannabinol (“THC”) is the principal psychoactive constituent of cannabis. However, THC is only one of 483 known compounds in the cannabis plant, including at least 84 other cannabinoids, such as cannabidiol (CBD), cannabinol (CBN), tetrahydrocannabivarin (THCV), and cannabigerol (CBG), as well as various terpenes, such as linalool, B-caryophyllene, D-limonene, Humulene, B-Myrcene, and/or a-Pinene).

A large variety of strains of the cannabis plant have been intentionally developed, for example to intensify specific pharmacological characteristics of the plant, e.g. by varying levels of THC and/or CBD, to vary the sensory impression of plant, such as taste, smell, appearance, e.g. by varying the levels of various terpenes, or to differentiate one strain from another for the purposes of marketing. Such strains may be either pure or hybrid varieties of cannabis species, typically cannabis sativa and cannabis indica. Strain names are typically chosen by their developer, and may reflect properties of the plant such as taste, color, smell, or the origin of the variety, or may be arbitrary or fanciful.

Components of the cannabis plant may be used in the manufacture of a variety of consumable cannabis-based products, e.g. dried flower buds, kief, hashish, hash oil, tincture, infusions, was, tea, topical preparations, and the like, which users may consume in a variety of ways, primarily smoking, vaporizing, and ingesting.

Experienced and novice cannabis users alike may desire the best subjective experience when using cannabis-based products. However, various users may have individualized subjective preferences for various cannabis-based products based upon those individuals' previous experiences and such users may desire to discover what other cannabis-based products, if any, provide similar experiences.

It is known in the art that various characteristics of a given cannabis-based product experience correlate with both positive and negative user experiences. Such factors include the levels of various chemically measurable characteristics of a particular cannabis-based product (e.g. the level(s) of CBD, THC, and/or various terpenes). Such factors may also include the geographical and/or commercial source of the cannabis-based product's components, pre-harvest agricultural techniques used in production of the cannabis plant (e.g. organic, hydroponic, grown indoor/outdoor, etc.), post-harvest processing techniques applied to the harvested cannabis, the form of the consumable cannabis-based product, the method of consumption, and the amount consumed.

It follows that a given user's experiences with cannabis-based products may be categorized according to various dimensions, including the name of the strain (or strains) of cannabis plant making up, or used in the production of, the cannabis-based product; the name of the geographical source of the cannabis plant; the name of the agricultural source of the cannabis plant; the name (or names) of any agricultural techniques used in the production of the cannabis plant; the name of the form of the consumable product; the name of the retail source of the cannabis-based product; the name of the method of consumption, and/or the amount consumed during the experience.

However, a cannabis user may not have a system for accessing the full set of data available for a given cannabis-based product; to maintain a journal or log of past cannabis experiences and the user's respective rankings or ratings of those cannabis-based products and experiences; or for comparing and contrasting their experiences to the experiences of other users. Additionally, more experienced cannabis users may not have a system for demonstrating their credibility and/or expertise in the field of judging, comparing, and/or otherwise analyzing cannabis-based products. Conversely, more novice users may not have system for gaining such expertise, aside from trial and error, and/or evaluating the credibility to be given to advice or suggestions received from others.

### BRIEF DESCRIPTION OF THE DRAWINGS

FIG. 1 illustrates an exemplary network topology of a cannabis-product recommendation and social-networking system in accordance with at least one embodiment.

FIG. 2 illustrates several components of an exemplary client device in accordance with at least one embodiment.

FIG. 3 illustrates a several components of an exemplary server device in accordance with at least one embodiment.

FIG. 4 illustrates an exemplary series of communications between various components in accordance with at least one embodiment.

FIG. 5 illustrates a flow diagram of an exemplary review data interface routine suitable for use in accordance with at least one embodiment.

FIG. 6 illustrates a flow diagram of an exemplary new review data set update routine suitable for use in accordance with at least one embodiment.

FIG. 7 illustrates a flow diagram of an exemplary cannabis-related product meta rating generation routine suitable for use in accordance with at least one embodiment.

FIG. 8 illustrates a flow diagram of an exemplary confidence score generation sub-routine suitable for use in accordance with at least one embodiment.

FIG. 9 illustrates a flow diagram of an exemplary personal credibility rating generation sub-routine suitable for use in accordance with at least one embodiment.

FIGS. 10A-B illustrate an exemplary search interface routine suitable for use in accordance with at least one embodiment.

FIG. 11 illustrates an exemplary search request routine suitable for use in accordance with at least one embodiment.

### DESCRIPTION

The detailed description that follows is represented largely in terms of processes and symbolic representations of operations by conventional computer components, including processors, memory storage devices for the processors, connected display devices, and input devices. Furthermore, these processes and operations may utilize conventional computer components in a heterogeneous distributed computing environment, including remote file servers, computer servers, and memory storage devices. Each of these conventional distributed computing components is accessible by the processor via a communication network.

The phrases “in one embodiment,” “in at least one embodiment,” “in various embodiments,” “in some embodiments,” and the like may be used repeatedly herein. Such phrases do not necessarily refer to the same embodiment. The terms “comprising,” “having,” and “including” are synonymous, unless the context dictates otherwise. Various embodiments are described in the context of a typical “hybrid” video coding approach, as was described generally above, in that it uses inter-/intra-picture prediction and transform coding.

As used herein, “cannabis-based products” includes cannabis in all forms including hemp and also as it pertains to synthetic formations of THC or CBD or other cannabis sourced components of cannabis.

Reference is now made in detail to the description of the embodiments as illustrated in the drawings. While embodiments are described in connection with the drawings and related descriptions, it will be appreciated by those of ordinary skill in the art that alternate and/or equivalent implementations may be substituted for the specific embodiments shown and described, including all alternatives, modifications, and equivalents, whether or not explicitly illustrated and/or described, without departing from the scope of the present disclosure. In various alternate embodiments, additional devices, or combinations of illustrated devices, may be added to, or combined, without limiting the scope to the embodiments disclosed herein.

### Exemplary Network Topology of a Cannabis-Product Recommendation and Social-Networking System

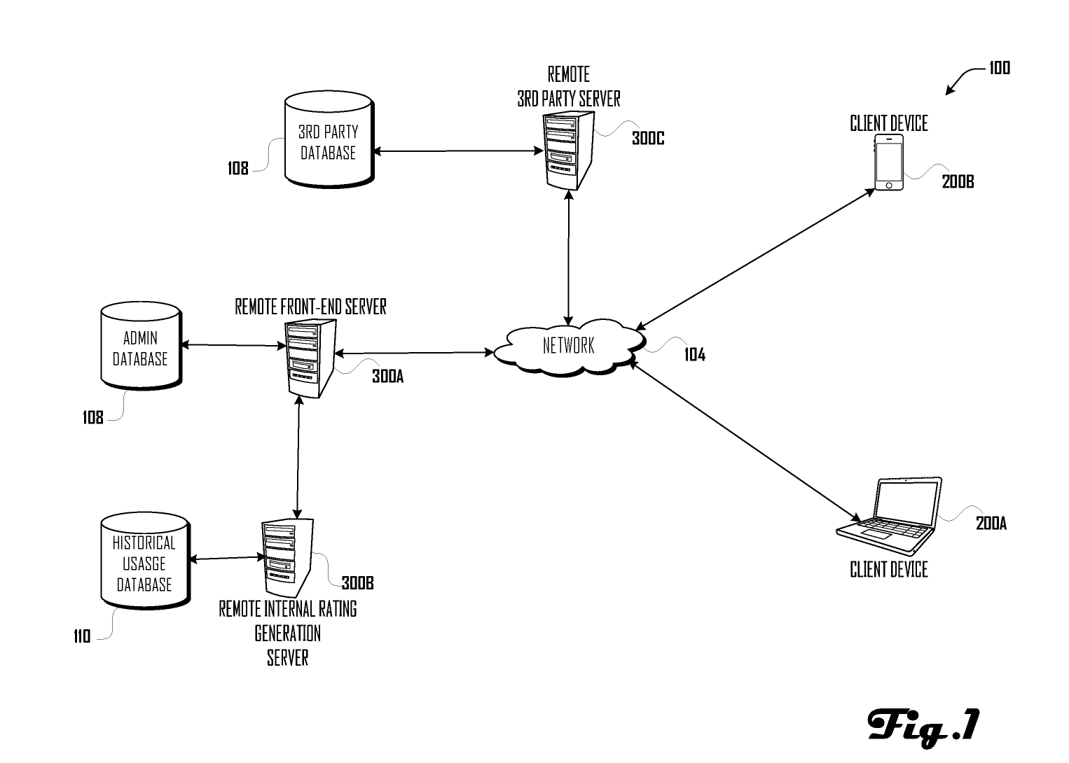

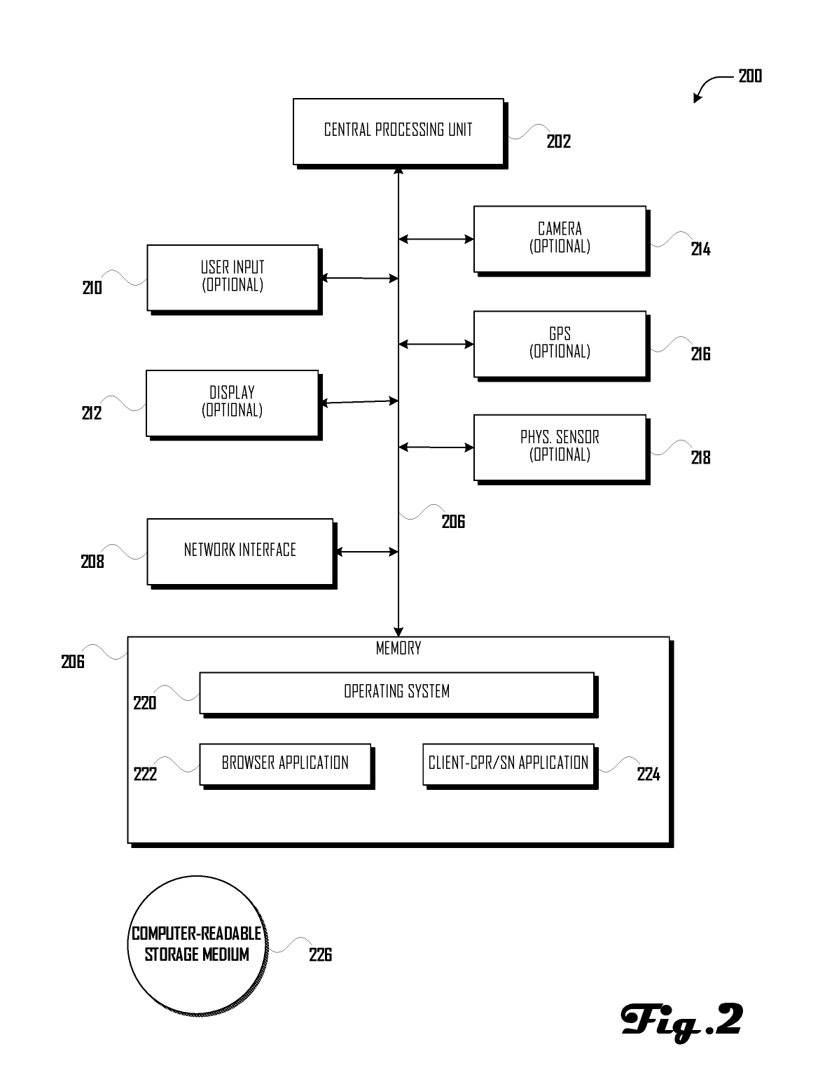

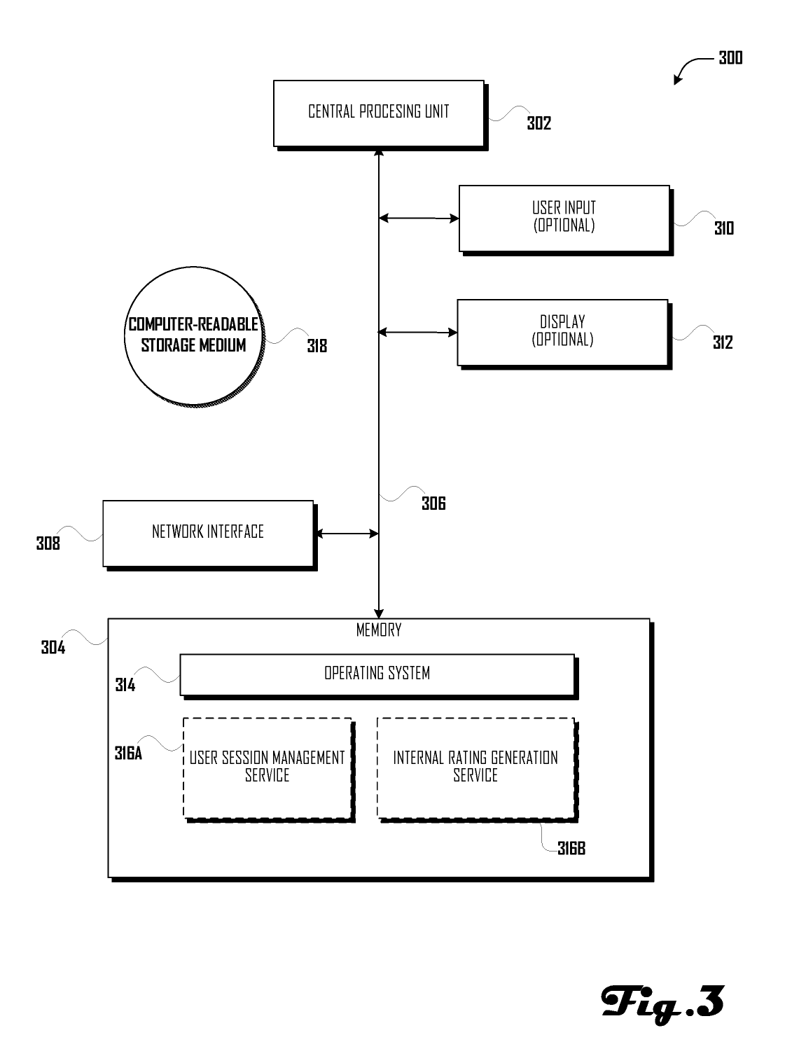

FIG. 1 illustrates an exemplary network topology 100 of a cannabis-based product recommendation and social-networking (CPR/SN) system in accordance with various embodiments. Client devices 200A-B (illustrated in FIG. 2 and described below), remote front-end server 300A, and remote internal rating generation server 300B (illustrated in FIG. 3 and described below) are in data communication with a network 104. In this and other embodiments, network 104 may include the Internet, one or more local area networks (“LANs”), one or more wide area networks (“WANs”), cellular data networks, and/or other data networks. Network 104 may, at various points, be a wired and/or wireless network. Remote front-end server 300A may be in data communication with an administrative database 108 and internal rating generation server 300B may be in data communication with a historical usage database 110, either through a direct data connection, such as a storage area network (“SAN”), a high speed serial bus, and/or via other suitable communication technology, or via network 104 (not shown). In some embodiments, remote front-end server 300A, remote internal rating generation server 300B, administrative database 108, and/or historical usage database 110 may comprise one or more replicated and/or distributed physical or logical devices. In many embodiments, there may be more client devices 200 than are illustrated.

In various embodiments, client devices 200, such as client devices 200A-B each may be a networked computing device having a form factor such as a mobile-phone; watch, heads-up display, or other wearable computing device; a dedicated media player; a computing tablet; a motor vehicle head unit; a gaming device; a “set-top box;” a television; or a general purpose computer. For simplified exemplary purposes, two client devices are shown, one of which is depicted as a mobile phone and the other of which is depicted as a laptop computer. In various embodiments there may be many more client devices 200. The primary functional components of an exemplary, form-factor-independent client device 200 are described below in reference to FIG. 2.

In various embodiments, remote front-end server 300A and remote internal rating generation server 300B may be networked computing devices generally capable of accepting requests over network 108, e.g. from client devices 200, each other, various databases, and/or other networked computing devices (not shown), and providing responses accordingly. The primary functional components of an exemplary remote server 300, such as remote front-end server 300A and remote internal rating generation server 300B, as well as optional 3rd party sever 300C, are described below in reference to FIG. 3.

### An Exemplary Client Device

Referring to FIG. 2, several components of an exemplary client device 200, such as any one of client devices 200A-B, is illustrated. In some embodiments, a client device may include many more components than those shown in FIG. 2. However, it is not necessary that all of these generally conventional components be shown in order to disclose an illustrative embodiment. As shown in FIG. 2, exemplary client device 200 includes a central processing unit 202 in data communication with memory 204 via a bus 206.

Central processing unit 202 is an electronic circuit designed to carry out instructions of a computer program, e.g. obtained from memory 204, by performing the basic arithmetic, logical, control and input/output (I/O) operations specified by the program's instructions. Memory 204 generally comprises some or all of random access memory (RAM), read-only memory (ROM), and/or a permanent mass storage device, such as a disk drive, flash memory, or the like. Bus 206 is a communication system that transfers data between components within client device 200, and includes any related hardware components (wire, optical fiber, etc.) and software, including communication protocols.

Client device 200 may also include a network interface 208 for connecting to a network such as network 104, one or more optional user input device(s) 210, e.g. an alphanumeric keyboard, keypad, a mouse or other pointing device, a touchscreen, and/or a microphone, (or a user input port for connecting an external user input device), an optional display 212, an optional camera 214, an optional global-positioning-system unit 216, and one or more optional physiological sensors 218, all interconnected along with the network interface 208 via bus 206.

Memory 204 of exemplary client devices may store program code, executable by central processing unit 202, corresponding to an operating system 220, as well as program code corresponding to a browser application 222, a client CPR/SN application 224, and other software applications (not shown). These and other software components may be loaded into memory 206 via network interface 208 or via a computer readable storage medium 226, such as a hard-disk drive, a solid-state drive, an optical disc, a removable memory card, and/or the like.

In operation, operating system 220 manages the hardware and software resources of the client device 200 and provides common services and memory allocation for various software applications, such as client CPR/SN application 224. For hardware functions such as network communications via network interface 204, receiving data via input 213, outputting data via optional display 214, and allocation of memory 212 for various software applications, such as client CPR/SN application 224, operating system 224 acts as an intermediary between software executing on the client device and the device's hardware. For example, operating system 224 may cause a representation of available software applications, such as CPR/SN application 400, to be presented to a user of client device 200 via display 214. If the user indicates, e.g. via input 213, a desire to use CPR/SN application 400, operating system 224 may instantiate a CPR/SN-application process (not shown), i.e. cause processing unit 208 to begin executing the executable instructions of the CPR/SN application and allocate a portion of memory 212 for its use.

Although an exemplary client device 200 has been described that generally conforms to conventional general purpose computing devices, a client device may be any of a great number of devices capable of communicating with network 108 and executing instructions for performing client CPR/SN application 224.

### An Exemplary Remote Server

Referring now to FIG. 3, several components of an exemplary remote server 300, such as remote front-end server 300A, remote internal rating generation server 300B and optional remote third party server 300C, in accordance with at least one exemplary embodiment are illustrated. In some embodiments, a remote server 300 may include many more components than those shown in FIG. 3. However, it is not necessary that all of these generally conventional components be shown in order to disclose an illustrative embodiment. As shown in FIG. 3, a remote server 300 includes a central processing unit 302 and memory 304 connected by a bus 306.

Central processing unit 302 is an electronic circuit designed to carry out instructions of a computer program, e.g. obtained from memory 304, by performing the basic arithmetic, logical, control and input/output (I/O) operations specified by the program's instructions. Memory 304 generally comprises some or all of random access memory (RAM), read-only memory (ROM), and/or a permanent mass storage device, such as a disk drive, flash memory, or the like. Bus 306 is communication system that transfers data between components within exemplary remote server 300, and includes any related hardware components (wire, optical fiber, etc.) and software, including communication protocols.

Remote server 300 may also include a network interface 308 for connecting to a network such as network 104, one or more optional user input device(s) 310, e.g. an alphanumeric keyboard, keypad, a mouse or other pointing device, a touchscreen, and/or a microphone, (or a user input port for connecting an external user input device) and/or an optional display 312 (or a display port for connecting an external display device), both interconnected along with the network interface 308 via bus 306.

Memory 308 stores an operating system 314 and program code for various software services. For example, remote front-end server 300A may include executable instructions for performing remote user session management service 316A (indicated by dotted lines) and remote internal rating generation server 300B may include executable instructions for performing remote internal rating generation service 316B (indicated by dotted lines).

Program code for these and other such software services or other software components may be loaded into memory 304 from a non-transient computer readable storage medium 318 using a drive mechanism (not shown) associated with the non-transient computer readable storage medium, such as, but not limited to, a DVD/CD-ROM drive, memory card, or the like. Software components may also be loaded into memory 304 via the network interface 308, rather than via a computer readable storage medium 328. Remote server 300 may also communicate via bus 306 with a database, such as admin database 108 and/or historical usage database 110, or other local or remote data store (not shown). In some embodiments, a remote server 300 may comprise one or more replicated and/or distributed physical or logical devices. In some embodiments, one or more of remote front-end server 300A and remote internal rating generation server 300B may be embodied by the same physical device.

### Cannabis-Based Product Recommendation and Social-Networking Service

Referring collectively to FIGS. 1-3, instances of client CPR/SN application 224 and remote internal rating generation service 316B may be operated in furtherance of a CPR/SN system (not shown) seeking to provide one or more cannabis-based product based services to users, including: a cannabis-based product experience journaling service; a cannabis-based product recommendation service; a cannabis-based product based social networking service; a cannabis-based product based content distribution service; a cannabis-based product based data-aggregation and distribution service; and/or a cannabis-based product expertise ranking service.

CPR/SN system may provide a user with the ability to create one or more user-identities for accessing the other features of the CPR/SN system, such as providing reviews with respect to the user's cannabis-based product experiences, searching for reviews provided by other users with respect to the other users' cannabis-based product experiences, communicating with other users, and the like. A user's user-identity, or user-name, may be a string of alphanumeric characters selected by the user. CPR/SN system may associate the user selected user-identity with a corresponding internal user identifier. If a single user has multiple user-identities, all of the user's user-identities may be associated with a single internal user identifier. After creating a user-identity, the user will be able to create, update, and/or view a corresponding user-profile and cannabis-based product experience log, including the user's subjective reviews of cannabis-based products and cannabis-based product experiences, described below. CPR/SN system may allow users to selectively choose to have a user-identity linked the user's actual identity (e.g. by including personally identifiable information in the user-profile associating the user-identity with user's actual identity, such as the user's legal name, email address, and/or user-identity on a social network service). CPR/SN system may allow users to selectively make various aspects of their user-profile and/or cannabis-based product experience log available for indexing and processing by components of CPR/SN system, such as front-end service 316A (e.g. for viewing by other users of CPR/SN system) or internal rating generation service 316B (e.g. for generating internal ratings, as explained below). CPRSN system may allow users to selective associate various descriptive attributes with their user profile, for example regarding preferences, levels of expertise and/or experience, relation to the cannabis-based product industry, and the like.

CPR/SN system may also allow users to monitor their cannabis intake. For example, by recording accurate information about a user's cannabis consumption, a user may track changes in usage over time, and therefore define and track progress towards goals, such as reducing consumption levels or mitigation of pain.

### Search, View, and Endorse Attributes of Other User Profiles

The CPR/SN system may provide a user with other-user “matches” or “suggested” user-identities by comparing each user-identity's subjective ratings of cannabis-based product experiences to those of others. Such matching may be based on similarity of ratings and or rankings of similar cannabis-based products, strains, sources, and measurable characteristics, as well as experiential collected data variables. A user's ratings or rankings of a particular cannabis-based products or particular strain may be matched to other cannabis-based products or cannabis strains based upon the chemically measurable characteristics of the cannabis strains. In this fashion, users will be able to (1) browse other users' subjective rankings in order to uncover cannabis strains or cannabis-based products the user has not yet experienced and/or (2) obtain objective recommendations generated by internal rating generation service 316B, as is described in more detail below, for example recommendations regarding cannabis strains that have been measured as chemically similar to the user's existing top-rated/top-ranked strain(s) and are available within a particular geographical area.

The CPR/SN system may allow users to endorse the descriptive attributes of other users and/or “follow” other users in order to obtain updates, additions, and/or alterations to the followed users' user profile and cannabis experience log. Users may choose to follow other users based upon their credibility or the popularity of their reviews or based upon other factors. Users may also view and selectively provide indications of support for content submitted by other users (e.g. by “liking” the content). Users may build credibility in the system by having their attributes endorsed or their submitted content supported by other users. As is explained below, the CPR/SN system associates a user credibility rating with a user identity and may dynamically increase (or decrease) the user's credibility rating as more data is obtained by the CPR/SN system. As the user takes actions and based upon the related actions of other users, with regard to the initial user's endorsements of their attributes or their reviews, the CPR/SN system may accordingly modulate the user's credibility level. Such modulation may be based at least in part on the subjective and objective quality of the user's rankings, ratings, and other recommendations, as assessed by the number of endorsements of attributes, followers and other interactions with other users of the CPR/SN.

All of these calculations, recommendations, and determinations may be dynamically updated as new information is obtained by the CPR/SN system and/or on a periodic basis.

### Provide Reviews

In accordance with the present methods and systems, the CPR/SN system may provide users with the ability to provide subjective reviews and ratings of cannabis-based products and related cannabis-based product experiences to add to the user's cannabis experience log. For example, CPR/SN application 224 may render a review creation interface, e.g. via display 212. The review creation interface may prompt the user to supply: (1) subjective ratings of a particular experience with a specific cannabis-based product regarding one or more categories, such as the taste, the intensity of the psychoactive and/or physiological effects, the overall quality of the cannabis-based product, and the like and (2) objective product and experience descriptors (or tags) for defining the cannabis-based product and/or cannabis-based product experience the user is rating. For example, a cannabis-based product and/or cannabis-based product experience may be defined by specifying values for one or more of the following categories of descriptors:
(1) strain descriptors corresponding to the strain of cannabis plant making up, or used in the production of, the cannabis-based product;
(2) geographic descriptors corresponding to the geographical source of the cannabis plant;
(3) a producer descriptor corresponding to the agricultural source of the cannabis plant;
(4) agricultural descriptors corresponding to any known agricultural techniques used in the production of the cannabis plant;
(5) product form descriptors corresponding to the form of the consumable product;
(6) supplier descriptors corresponding to the retail source of the cannabis-based product;
(7) consumption descriptors corresponding to the method of consumption; and/or
(8) amount descriptors corresponding to the amount consumed.
   A user of a client device 200 may provide numerical rating values and alphanumeric descriptor values for categorizing the cannabis-based product and cannabis-based product experience (collectively referred to as a review data set) to client CPR/SN application 224, e.g. via user input 210. CPR/SN application 224 may automatically (or selectively) associate such review data with corresponding time and location data. CPR/SN application 223 may include an image capture capability a user may capture and associate an image of a cannabis-based product with a review data set. CPR/SN application 224 may provide a review data set to an instantiation of user session management service 316A operating on remote front-end server 300A. User session management service 316A may store the review data set, e.g. historical review database 110.

### Third Party Data

The CPR/SN system may also obtain information regarding specific cannabis-based products may be available from a third party source, such as the supplier or a state regulatory agency, for example if the user obtained the cannabis-based product from a supplier utilizing a “seed-to-sale” inventory tracking system (as may be required in a U.S. state that has legalized the sale of recreational cannabis-based products). Such a source may also have constituent testing data available for cannabis-based products, e.g. the measured level(s) of THC, CBD, and/or various terpenes, such as linalool, B-caryophyllene, D-limonene, Humulene, B-Myrcene, and/or a-Pinene in a particular cannabis-based product. The CPR/SN system may allow a user to input, scan, or otherwise capture an identifier on the cannabis-based product and, in response, the CPR/SN system may automatically populate the corresponding journal entry with such known information about the cannabis-based product available from the CPR/SN system and from third party sources. Users may also be able to access testing and other data associated with particular strain instances where third party testing companies have made the data available to the CPR/SN system or if it has been provided by the user. Such third party data may also be used by the CPR/SN system to calculate, extrapolate, or otherwise obtain dosage information regarding particular psychoactive constituents of the cannabis-based product consumed by the user during a particular experience.

The CPR/SN system may also search third party data-sources such as websites, social networks, journals, blogs, magazines, and the like for articles, posts, blog entries, or other sets of data related to cannabis and cannabis-based products, and, for each set of data found by the search, index the set of data for use in providing future search results and determine an associated confidence score or rating with respect to the set of data, or the source of the set of data, as is described in more detail below.

The CPR/SN system may also obtain data directly from cannabis-based product consuming devices. For example, a device may be equipped with a gas or liquid chromatograph component for measuring various chemical characteristics of cannabis-based products and providing related data to the CPR/SN system.

### Search, View, Preferences and Providing Indications of Support to Reviews

By way of further example, the CPR/SN system may permit users to rate their experiences with various cannabis-based products, and/or rank their experiences with various cannabis-based products with respect to one another. The CPR/SN system may generate a set of cannabis-based product recommendations for a user based on that user's previous ratings and reviews of cannabis-based products. Other criteria may be factored into the generated cannabis-based product recommendations, for example the user's location and/or a desired flavor, feeling, or price range. The user may further narrow their desired criteria based upon specific words, word families or ‘pins’ denoting their preferences or specific interests. The CPR/SN system may allow users to receive recommendations for particular strains of cannabis, recommended to be ingested a particular way, and recommended to be sourced from a certain geographical location and/or from a certain commercial cannabis-based product provider. The CPR/SN system may generate a new set of cannabis-based product recommendations for a user every time the user accesses the system or makes a change to their corresponding user-profile, preferences (‘pins’), attributes, and/or cannabis-based product experience log. The CPR/SN system may generate a new set of cannabis-based product recommendations for a user every time that any user adds information to the system, providing a new review data set, gaining or losing credibility points (described below), “liking” or “un-liking” a particular review data set, or changing their preferences (“pins”).

The CPR/SN system may allow users to search for cannabis-based products, cannabis related products, cannabis providers, and other cannabis related information, such as articles, reviews, and the like, based upon their selected preferences. For example, users may search for all instances of a particular cannabis strain, or category of cannabis strains (e.g. indica, sativa, hybrid) currently available in a particular form, such as flower, at a state-licensed recreational cannabis retailer within a five-mile radius of the user's current location. By way of further example, users may search for other users with similar subjective preferences, attributes, or geolocation of their reviews. In this fashion, users will be able to (1) browse other users' subjective rankings in order to uncover cannabis strains or cannabis-based products the user has not yet experienced and might prefer and/or (2) obtain objective ratings generated by internal rating generation service 316B, described below. In response to a search request from CPR/SN application 224, user session management service 316A may obtain historical usage data, e.g. from historical usage database 110, process the historical usage data, and provide responsive results.

In accordance with various embodiments of the present systems and methods, users may provide the CPR/SN system with review data regarding the users' subjective preferences with regard to various cannabis-based products. For example, the users may provide data corresponding to a numerical rating for the overall or quality of the experience relating to the user's use of a cannabis-based product, as well as a numerical rating for the flavor of the cannabis-based product, and the like.

As is described in more detail below, when user session management service 316A processes a request to provide a particular, “subject” review data set associated with a particular, “subject,” user identifier, the user session management service may request internal rating generation service 316B to provide a corresponding cannabis-based product meta (“CPM”) rating and a corresponding review credibility (“RC”) rating. A CPM rating is an aggregate numerical rating of a cannabis-based product and/or cannabis-based product experience, as defined by a set of objective product and experience descriptors supplied in the review data set, and an RC rating is an expression of the confidence in the CPM rating. User session management service 316A may then utilize CPM and RC ratings to rank search results, generate customized cannabis-based product recommendations, generate customized user suggestions, and the like.

### CPR/SN System Generated Ratings

When a user provides new content to the CPR/SN system, such as a review data set, journal entry, link, article, or the like, the CPR/SN system may determine an internal credibility rating and associate the internal confidence rating with the submitted content. In the case of a review data set, which may include a descriptor set defining a particular cannabis-based product and/or cannabis-based product experience and the user's subjective rating of the defined cannabis-based product or cannabis-based product experience, the CPR/SN system may also determine a cannabis-based product meta (“CPM”) rating.

The CPR/SN system may accordingly maintain a dynamic personal credibility rating Rₚ for users of the CPR/SN system. As described above, each user may associate various attributes with the user's user identity and obtain corresponding other-user attribute endorsements. Each user may also provide content submissions to the CPR/SN system and obtain corresponding other-user support indications (i.e. “likes”). Each user may also obtain other-user followers associated with the user's user identity. If a given user u has obtained:
E attribute endorsements from N other users, each i′th of N other user having a personal credibility rating of R_{p,i};
L support indications from M other users, each j′th of M other user having a personal credibility rating of R_{p,j}; and
F other-user followers, each k′th of F other user followers having a personal credibility rating of R_{p,k},
   Then, the user's personal credibility rating R_{p,u} may be calculated according to the equation:

R_{p,u}=q_{E}Σᵢ₌₁^{N}EᵢR_{p,i}+q_{L}Σⱼ₌₁^{M}LⱼR_{p,j}+q_{F}Σₖ₌₁^{F}R_{p,k}

Where q_{E}, q_{L}, and q_{F} represent optional scaling factors.

The CPR/SN system may utilize personal credibility ratings to determine a review confidence score Z for a review data set S provided by user u with respect to a super-set of N users (the super-set of N users may represent all users of the CPR/SN system, all recently active users of the CPR/SN system, all users of the CPR/SN system associated with at least one content submission, or the like). For example, for a current review data set S_{C} provided by a user u having a personal credibility rating of R_{p,u}, Z_{c} may be determined according to the equation:

$${Z}_{c} = {q}_{z , 1} \frac{{R}_{p , u}}{{R}_{tot}} + {q}_{z , 2} ( 1 - {R}_{p , u} ) \frac{{\sum }_{i = 1}^{N} {L}_{i} {R}_{p , i}}{{NR}_{T} {L}_{tot}}$$

Where, Rₜₒₜ represents the total sum of personal credibility ratings Rₚ for the super-set of N users, Lₜₒₜ represents the total number of support indications provided by the super-set of N users, and q_{z,1} and q_{z,2} represent optional scaling factors.

To generate a CPM rating for a current review data set S_{c} provided by a user u, the CPR/SN system may obtain historical usage data relating to other review sets provided by the subject user. For example, the current review data set S_{c} may include one or more user-provided raw numerical rating values. The CPR/SN system may utilize such user-provided raw numerical rating values to generate a raw subjective rating value W_{c} corresponding to the user's subjective rating of the cannabis-based product associated with current review data set

The CPR/SN system may normalize the raw numerical rating value W_{c} with respect to the user's historical review data set rating values in order to determine a normalized numerical rating value V_{c} for the current review data set S_{c}.

The CPR/SN system may also obtain historical usage data relating to historical normalized numerical ratings Vₕ associated with previously obtained historical review data sets from the super-set of N users and, for each of the historical review data sets, the CPR/SN system may determine: (1) a correlation factor k_{c,h} representative of the similarity of the descriptor set associated with the current review data set S_{c} and the descriptor set associated with the historical review data set Sₕ, (2) a confidence score Zₕ associated with the historical review data set, and (3) a normalized numerical rating value Vₕ associated with the historical review data set.

The correlation factor k_{i,S} between a current review set S_{c} and a historical review set Sᵢ may have a value between zero and one and be proportional to the commonality of the historical and current review data sets' descriptors, e.g. strain descriptors, producer identifiers, product form descriptors, supplier descriptors, and the like. For example, the similarity of the reviews' strain descriptors may be expressed by a value D. A temporal delta Δt, corresponding to the number of days between obtaining the historical review data set Sₕ and the current review data set S_{c} may also contribute to the correlation factor—e.g. a historical review provided on the same day as the subject review will have a higher correlation factor than a historical review obtained six months prior to obtaining the subject review. Each descriptor similarity value D may also be associated with a corresponding relevance weighting factor r.

For example, the correlation factor k_{c,h} between a current review set S_{c} and historical review set Sₕ may be calculated according to the equation:

k_{c,h}=rₛₜᵣₐᵢₙDₛₜᵣₐᵢₙ+r_{prod}D_{prod}+rₛᵤₚₚDₛᵤₚₚ+r_{con}D_{con}+r_{T}|Δt|

Where:

rₛₜᵣₐᵢₙ+r_{prod}+rₛᵤₚₚ+r_{con}+r_{T}=1

In at least one embodiment, for example, the similarity of the reviews' strain descriptors Dₛₜᵣₐᵢₙ may supply up to 35% of the value of the correlation factor between the reviews; the similarity of the reviews' producer descriptors D_{prod} may supply up to 25% of the value of the correlation factor between the reviews; the similarity of the reviews' supplier descriptors Dₛᵤₚₚ may supply up to 15% of the value of the correlation factor between the reviews; the similarity of the reviews' consumption descriptors D_{con} may supply up to 10% of the value of the correlation factor between the reviews; and the temporal delta Δt may also supply up to 15% the correlation factor.

CPM/SN service 316B may also utilize data obtained from third parties to refine/improve correlation factors between review data sets with otherwise diverging descriptors, e.g. a first review data set associated with a first strain descriptor may not correlate highly with a review data set associated with a second strain descriptor. However, third party data obtained from cannabis-based product testing service may indicate cannabis plants associated with the first strain descriptor may have an identical chemical profile as the cannabis plants associated with the second strain descriptor (indicating, for example, a single cannabis strain is associated with both the first and second strain descriptors).

The CPM rating for a current review set S_{c} with respect to historical usage data for a super-set of N users may be calculated according to the equation:

$${CPM}_{S} = {q}_{c , 1} \frac{{R}_{p , u} {Z}_{u} {V}_{S}}{{R}_{tot}} + {q}_{c , 2} \frac{( 1 - {R}_{p , u} ) {\sum }_{i = 1}^{N} ( {k}_{c , i} {Z}_{i} {V}_{i} )}{{NR}_{tot}}$$

Where q_{cpm} represents an optional scaling factor. The CPR/SN system may use CPM ratings to provide an aggregate, cross-user rating of a given cannabis-based product and/or cannabis-based product experience. The CPR/SN system may also use associated confidence scores Z to provide a measure of the system's confidence in the accuracy of a given CPM rating.

### Exemplary Series of Communications

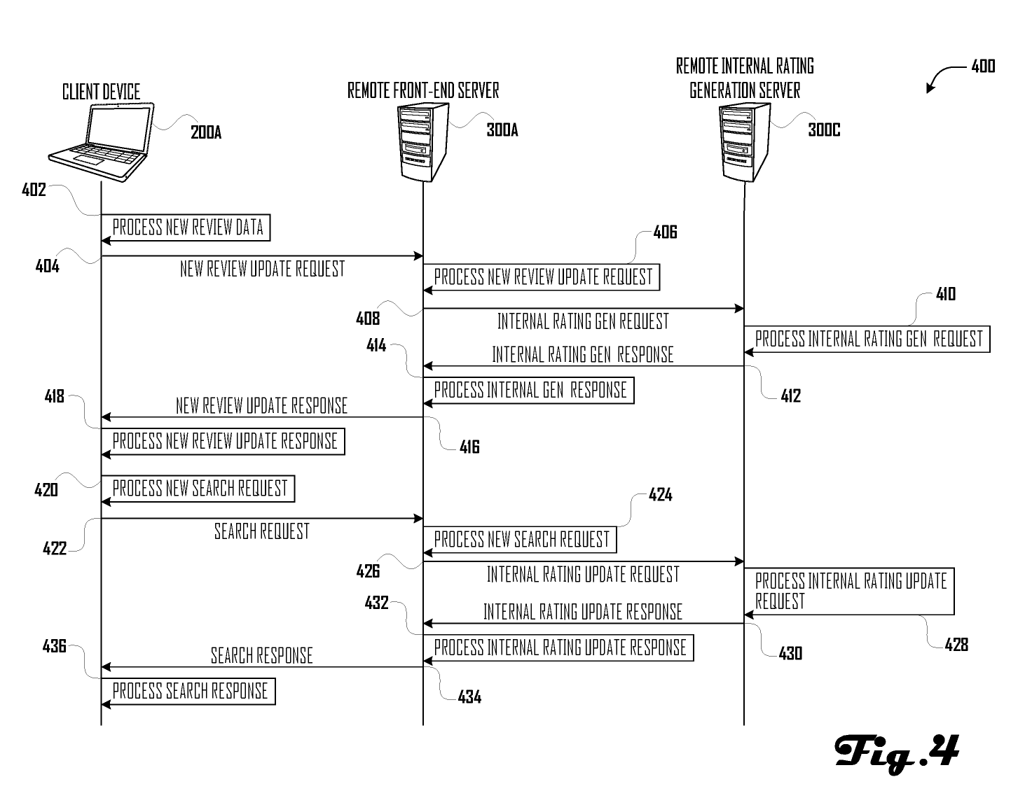

FIG. 4 illustrates an exemplary series of communications 400 between client device 200A, remote front-end server 300A, and remote internal rating generation server 300B in accordance with various embodiments of a CPR/SN system. Exemplary series of communications 400 is illustrated and described as relating to generating and searching for cannabis-based product reviews.

The illustration of exemplary series of communications 400 begins client device 200A processing 402 a new review data set, e.g. via optional user input 210.

Client device 200A may provide a corresponding new review data set update request 404 to remote front-end server 300A. New review data set update 404 may include a user session identifier associated with an instantiation of client CPR/SN application 224 operating on client device 200A.

Remote front-end server 300A may process 406 new review data set update request 404, e.g. by obtaining user data, such as a user identifier associated with the user session identifier and meta-data associated with the user identifier and by providing an internal rating generation request 408 to remote internal rating generation server 300B.

Remote internal rating generation server 300B may process 410 internal rating generation request 408, for example by performing instructions causing the remote internal rating generation server to analyze historical usage data in order generation CPM and RC ratings for the review data set. In some embodiments, for example, remote CPR/SN sever 300B may perform routine 700, described below in reference to FIG. 7. Remote internal rating generation server 300B may then provide an internal rating generation response 412. Internal rating generation response 412 may include data corresponding to new or updated CPM and RC ratings for the review data set.

Remote front-end server 300A may process 414 internal rating generation response 412 and provide a new review data set update response 416 to client device 200A. For example, remote front-end server 300A store the obtained CPM and RC ratings in administrative database 108, associated with the current user session identifier, and provide the obtained CPM and RC ratings to client device 200A in new review data set update response 416.

Client device 200A may process 418 new review data set update response 416, for example by causing optional display 212 to render human-comprehensible versions of the updated review data set.

Client device 200A may subsequently obtain 420 a search request, e.g. via optional user input 210, identifying at least one cannabis-based product descriptor (or search term). Client device 200A may responsively provide a search request 422 to remote front-end server 300A specifying the user session identifier and the cannabis-based product descriptor(s).

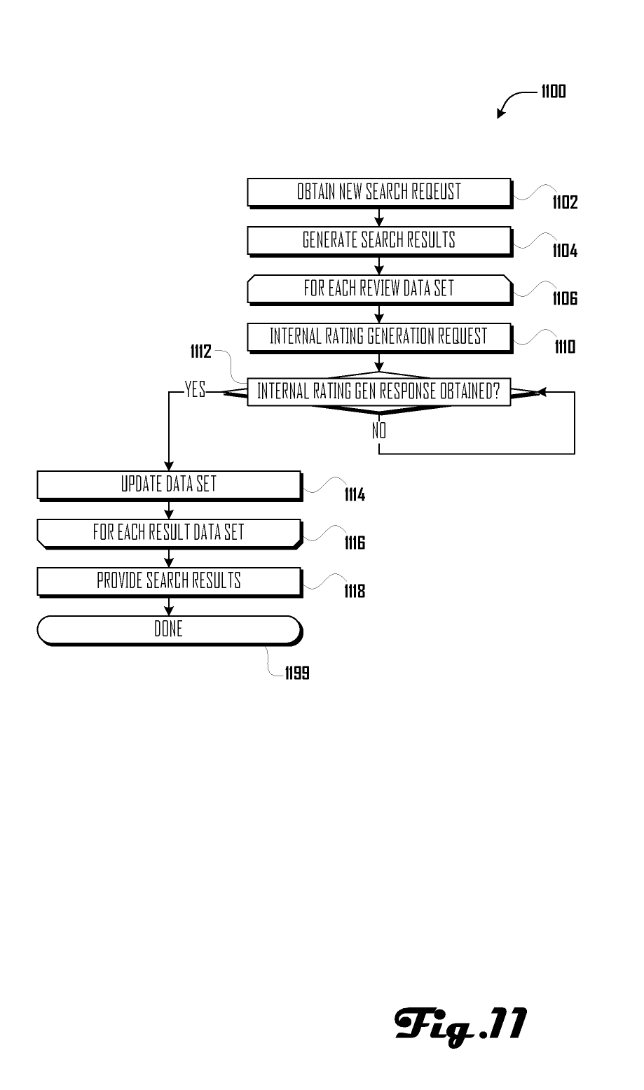

Remote front-end server 300A may process 424 search request 422 to obtain historical review sets (and other posts, articles, and the like) response to the cannabis-based product descriptor(s) and provide a corresponding internal rating update request 426 to remote internal rating generation server 300B. (As is described below in reference to FIG. 11, depending on the implementation, remote front-end server 300A may provide an internal rating update requests to remote internal rating generation server 300B for each historical review set obtained as a search result.)

Remote CPR/SN sever 300B may process 428 internal rating update request 426. In some embodiments, for example, remote CPR/SN sever 300B may perform routine 700 and recalculate a new CPM and RC rating for each specified historical review set. Remote internal rating generation server 300B may then provide an internal rating update response 430. Internal rating update response 430 may include data corresponding to new or updated CPM and RC ratings for one or more historical review data sets.

Remote front-end server 300A may process 432 internal rating update response 430 and provide a search response 434 to client device 200A. For example, remote front-end server 300A may update the historical review data sets with the updated CPM and RC values, and provide the updated historical review data sets to client device 200A in search response 434.

Client device 200A may then process 436 search response 434, e.g. by ranking and rendering the historical review data sets via display 212.

### Exemplary Review Data Interface Routine

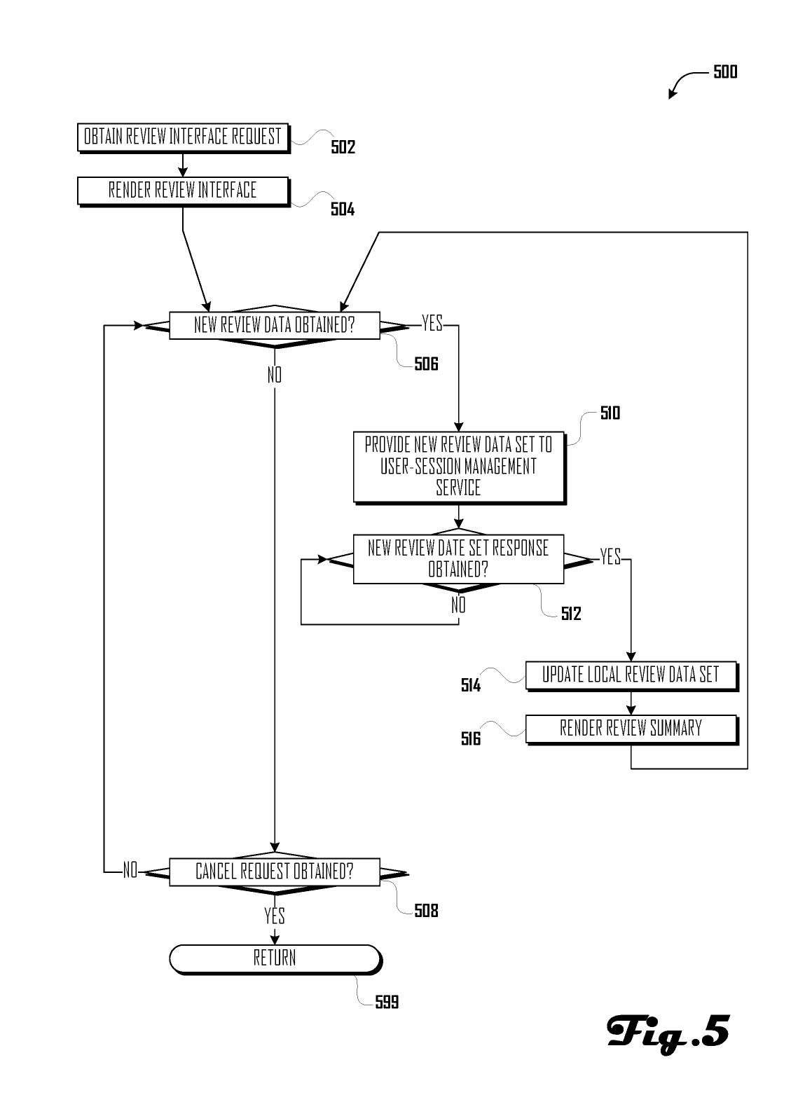

FIG. 5 illustrates an exemplary routine 500, which may be implemented by an instantiation of client CPR/SN application 224 operating on a client device, such as client device 200A. For example, a user may indicate to the instantiation of client CPR/SN application 224 via user input 210 that user would like to provide a review of a cannabis-based product and/or cannabis-based product experience and the client CPR/SN application may responsively execute instructions corresponding to routine 500.

Routine 500 may obtain a review interface request at execution block 502.

Routine 500 may render a review interface, e.g. via display 212, at execution block 504.

At decision block 506, if new data is obtained, e.g. via user input 210, then routine 500 may proceed to execution block 510; otherwise routine 500 may proceed to decision block 508.

At decision block 508, if a cancel request is obtained, e.g. via user input 210, then routine 500 may proceed to return block 599; otherwise routine 500 may return to decision block 506.

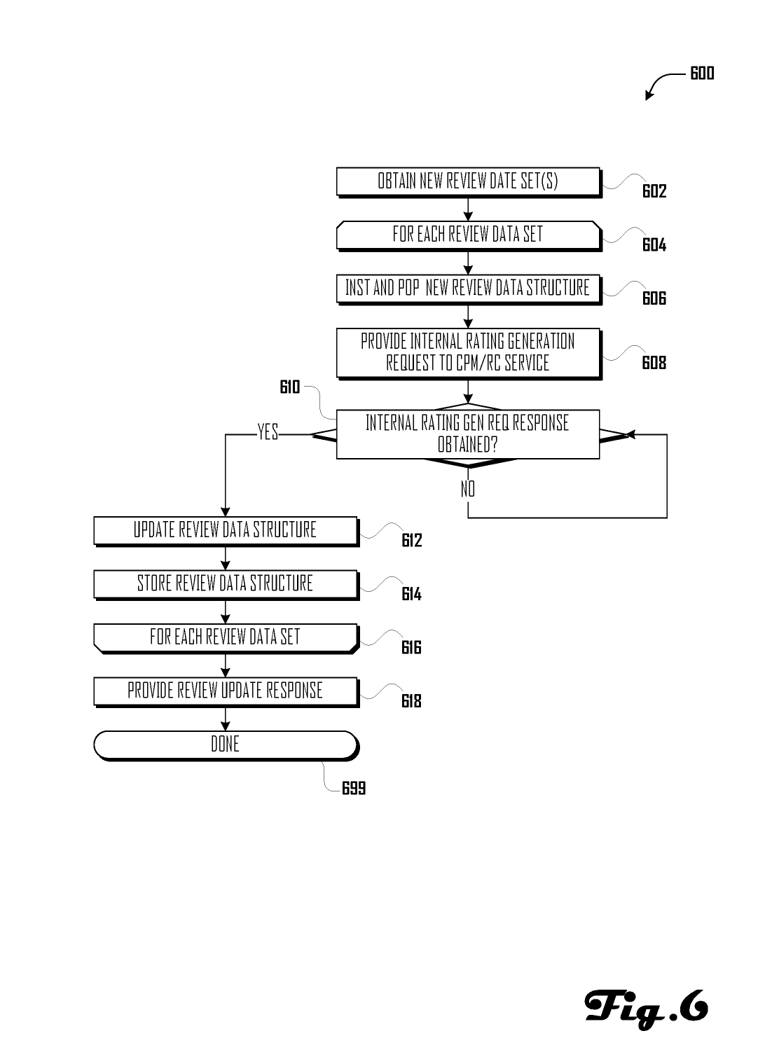

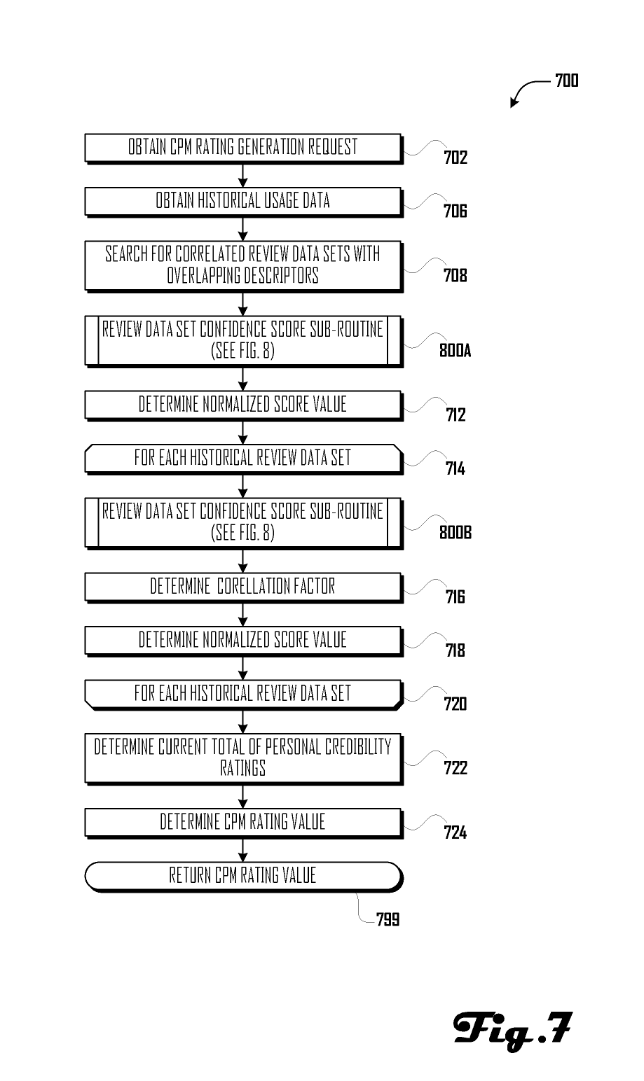

Routine 500 may provide a new review data set, e.g. corresponding to data obtained via user input 210 at decision block 506, to user session management service 316A operating on remote front end server 300A at execution block 510. Exemplary routine 600, described below in reference to FIG. 6, provides an example of how remote front end server 300A may process such a new review data set.

At decision block 512, if routine 500 has obtained a new review data set response from user session management service 316A, routine 500 may proceed to execution block 514; otherwise routine 500 may continue to wait for a response for user session management service 316A.

Routine 500 may update the locally stored review data set to incorporate the contents of the new review data set response obtained from user session management service 316A at execution block 514. For example, as is described below, the new review data set response may include a CPM and/or RC rating corresponding to the review data set, which routine 500 may associate with the review data set in memory 206.

Routine 500 may render a summary of the review data set at execution block 516 and then return to decision block 506.

Routine 500 may terminate, e.g. upon obtaining a cancel request via user input 210, at return block 599.

### Exemplary New Review Data Set Update Routine

FIG. 6 illustrates an exemplary routine 600, which may be implemented by user session management service 316A operating on remote front-end sever 300A. For example, an instantiation of client CPR/SN application 224 associated with an existing user session may provide one or more new review data sets and the user-session management service may responsively execute instructions corresponding to routine 600.

Routine 600 obtains one or more new review data sets, e.g. as part of a new review update request obtained from client CPR/SN application 224, at execution block 602.

At starting loop block 604, routine 600 may process each obtained new review data set in turn.

Routine 600 may instantiate a new review data structure and populate the new review data structure with the data from the current review data set at execution block 606.

Routine 600 may provide an internal rating generation request to internal rating generation service 316B operating on remote internal rating generation server 300B at execution block 608. Exemplary routine 700, described below in reference to FIG. 7, provides an example of how remote CPM/RC server 300B may process such an internal rating generation request.

At decision block 610, if routine 600 obtains an internal rating generation response from internal rating generation service 316B, then routine 600 may proceed to execution block 612.

Routine 600 may update the new review data structure with data obtained from the internal rating generation response at execution block 612.

Routine 600 may store the new review data structure, e.g. in administrative data base 108, at execution block 614.

At ending loop block 616, routine 600 may loop back to starting loop block 604 and process the next review data set, if any.

Routine 600 may provide a review update response to the new review update request, including the newly created review data structure(s), at execution block 618.

Routine 600 may terminate at ending block 699.

### Exemplary CPR Rating Generation Routine

FIG. 7 illustrates an exemplary routine 700, which may be implemented by internal rating generation service 316B operating on remote internal rating generation server 300B. For example, an instantiation of user session management service 315A associated with an existing user session may provide one or more internal rating generation requests specifying a review data set and requesting a CPM rating to internal rating generation service 316B and the internal rating generation service may responsively execute instructions corresponding to routine 700.

Routine 700 obtains an internal CPM rating generation request at execution block 702. The internal CPM rating generation request may include a user identifier and a review data set.

Routine 700 may obtain historical usage data associated with the user identifier, e.g. from historical usage database 110, at execution block 706. For example, the historical usage data may include a set of previously provided raw numerical rating values associated with the user identifier.

Sub-routine 700 may search for and obtain one or more historical review data sets associated with at least one of the obtained descriptor values, e.g. from historical usage data base 110, at execution block 708.

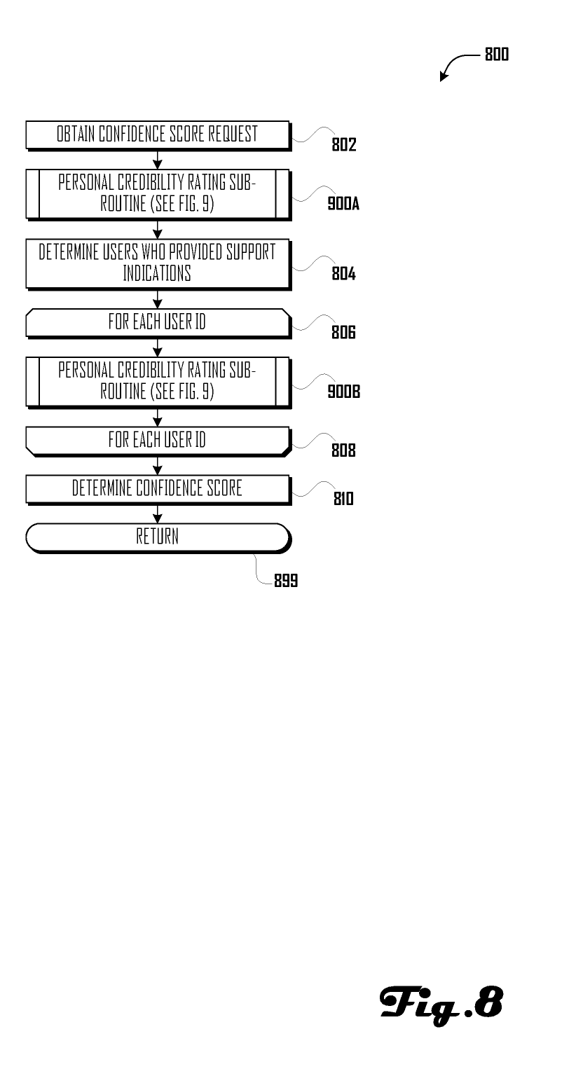

At sub-routine block 800A, routine 700 may call sub-routine 800, described below with reference to FIG. 8. Routine 700 may provide sub-routine 800 with the user identifier associated with the review data set obtained in the internal rating generation request. Sub-routine 800 may return a personal credibility rating associated with the user identifier and a review data set confidence score associated with the review data set.

Routine 700 may determine a normalized rating value corresponding to the raw numerical rating value at execution block 712. For example, the raw numerical rating value may be normalized with respect to the set of previously provided raw numerical rating values associated with the user identifier.

At starting loop block 714, sub-routine 700 may process each historical data set in turn.

At sub-routine block 800B, routine 700 may again call sub-routine 800. Routine 700 may provide sub-routine 800 with the user identifier associated with the current historical review data set. Sub-routine 800 may return a review data set confidence score associated with the historical review data set.

Sub-routine 700 may determine a correlation factor between the descriptors associated with the current historical data set and the obtained descriptor values at execution block 716.

Sub-routine 700 may determine normalized rating value associated with the historical data set at execution block 718.

At ending loop block 720, sub-routine 700 may loop back to starting loop block 714 to process the next historical review data set, if any.

Routine 700 may determine a current total of all personal credibility ratings obtained from sub-routine 800 at execution block 722.

Sub-routine 700 may determine a CPM rating value for the current review data set at execution block 730.

### Exemplary Review Data Set Confidence Score Sub Routine

FIG. 8 illustrates an exemplary sub-routine 800, which may be implemented by internal rating generation service 316B operating on remote internal rating generation server 300B. For example, routine 700 may call sub-routine 800 in order to generate (or update) an RC rating for a review data set associated with a user identifier.

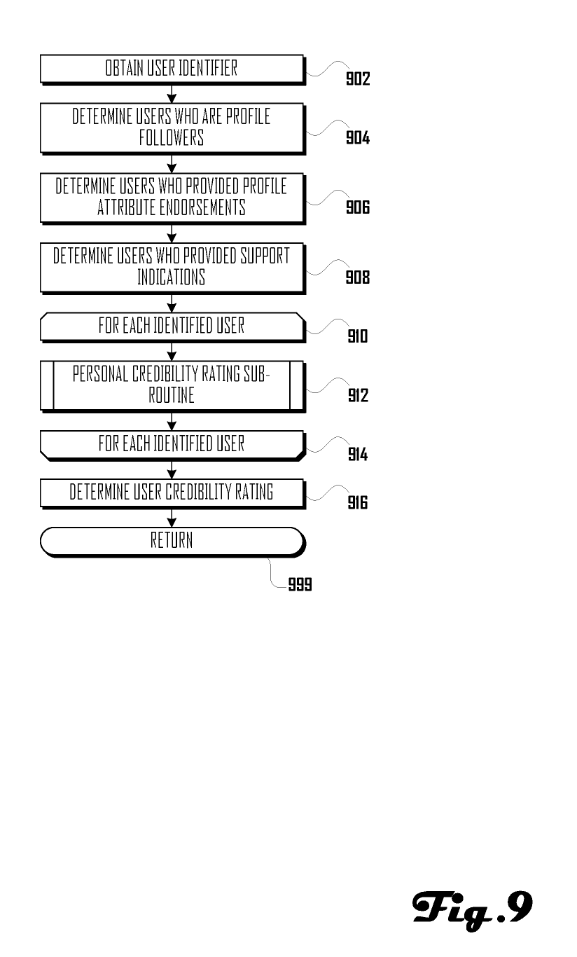

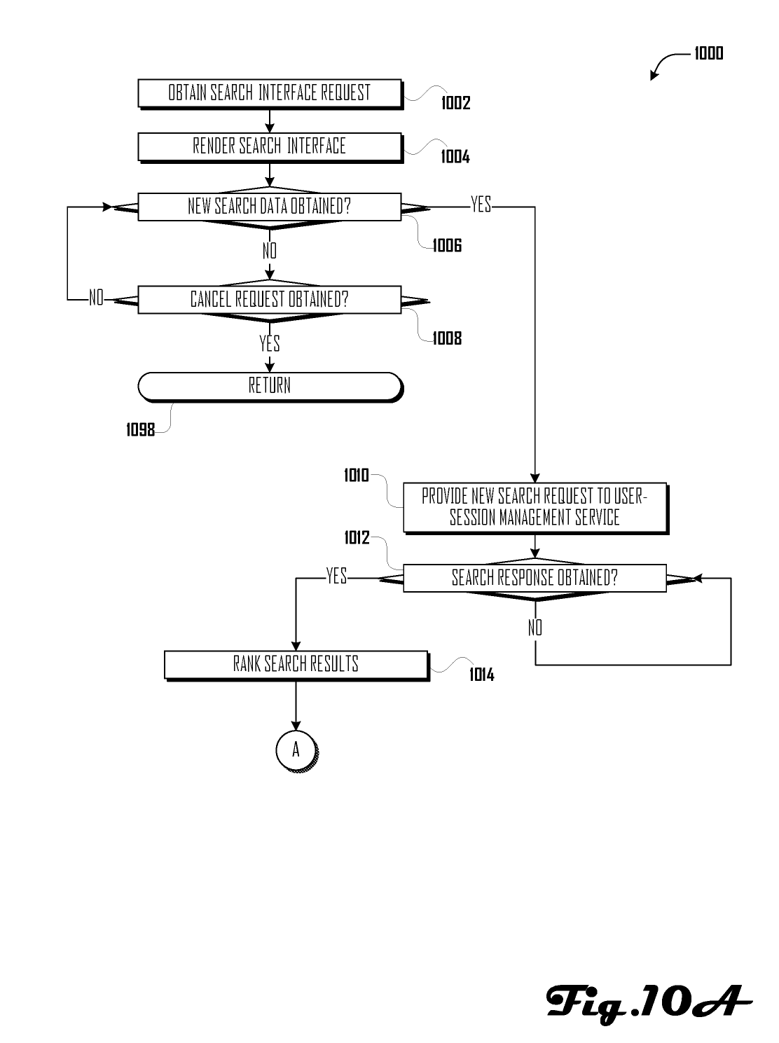

At sub-routine block 900A, sub-routine 800 may call sub-routine 900, described below in reference to FIG. 9. Sub-routine 800 may provide sub-routine 900 with the user identifier associated with the review data set obtained in the internal rating generation request. Sub-routine 900 may return a personal credibility rating associated with the user identifier.

Sub-routine 900 may determine those user identities who provided with any support indications associated with the current review data set at execution block 804.

At starting loop block 806, sub-routine 800 may process each user identity in turn.

At sub-routine block 900B, sub-routine 800 may again call sub-routine 900. Sub-routine 800 may provide sub-routine 900 with the current user identity. Sub-routine 900 may return a personal credibility rating associated with the user identity.

At ending loop block 808, sub-routine 800 may loop back to starting loop block 806 to process the next user identity, if any.

Sub-routine 800 may determine a confidence score for the review data set at execution block 810.

Sub-routine may end by returning the confidence score for the review data set and the personal credibility rating for the associated user identifier at return block 899.

### Exemplary Personal Credibility Rating Sub-Routine

FIG. 9 illustrates an exemplary sub-routine 900, which may be implemented by internal rating generation service 316B operating on remote internal rating generation server 300B. For example, routine 800 may call sub-routine 900 in order to generate (or update) a personal credibility rating for a user identifier.

Sub-routine 900 may obtain a user identifier at execution block 902.

Sub-routine 900 may determine a set of users who are of followers of the user profile associated with the obtained user identifier at execution block 904.

Sub-routine 900 may determine a set of users who provided profile attribute endorsements to the user profile associated with the obtained user identifier at execution block 906.

Sub-routine 900 may determine a set of users who provided support indications to historical content submissions associated with the obtained user identifier at execution block 908.

At starting loop block 910, sub-routine 900 may process each user in the set of users in turn.

At sub-routine block 912, sub-routine 900 may recursively call itself. The current instantiation of sub-routine 900 may provide the called instantiation of sub-routine 900 with a user identity associated with the current user of the set of users. Sub-routine 900 may return a personal credibility rating associated with the user identity.

At ending loop block 914, sub-routine 900 may process the next user in the set of users in turn.

Sub-routine 900 may determine a personal credibility rating for the obtained user identifier at execution block 916.

Sub-routine 900 may end by returning the personal credibility rating at termination block 999.

### Exemplary Search Interface Routine

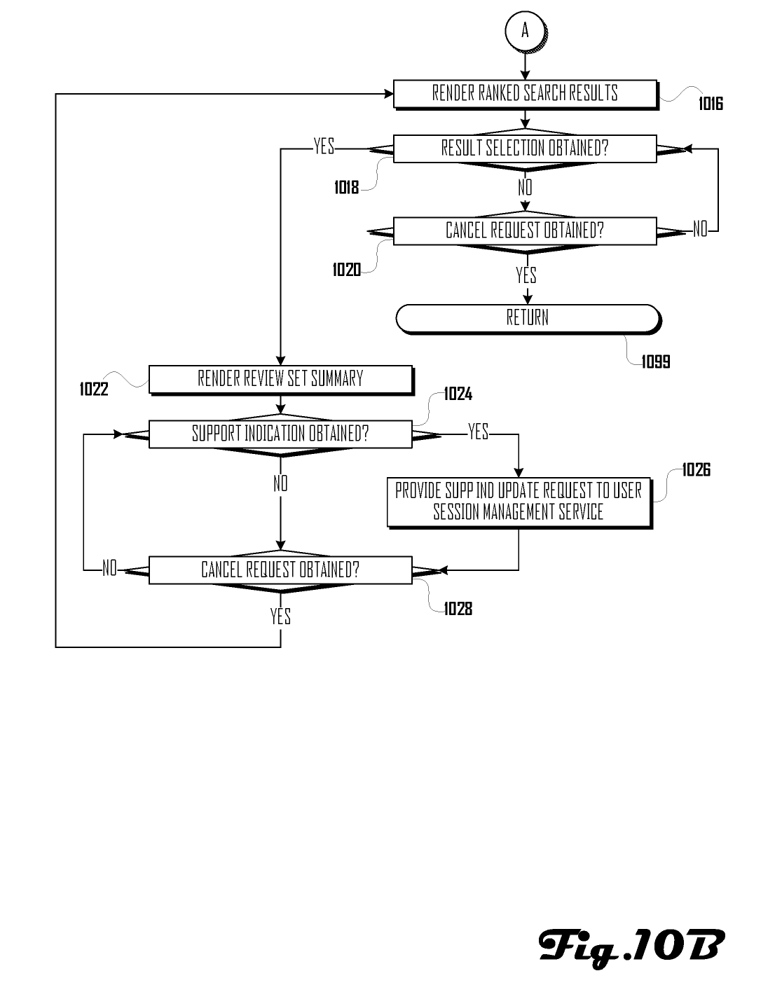

FIGS. 10A-B illustrate an exemplary routine 100, which may be implemented by an instantiation of client CPR/SN application 224 operating on a client device, such as client device 200A. For example, a user may indicate to the instantiation of client CPR/SN application 224 via user input 210 that user would like to view recommendations of cannabis-based products and/or cannabis-based product experiences and the client CPR/SN application may responsively execute instructions corresponding to routine 1000.

Referring to FIG. 10A, routine 1000 may obtain a search interface request at execution block 1002.

Routine 1000 may render a search interface, e.g. via display 212, at execution block 1004.

At decision block 1006, if new search data is obtained, e.g. via user input 210, then routine 1000 may proceed to execution block 1010; otherwise routine 1000 may proceed to decision block 1008.

At decision block 1008, if a cancel request is obtained, e.g. via user input 210, then routine 1000 may proceed to return block 1098; otherwise routine 1000 may return to decision block 1006.

Routine 1000 may provide a new search data set, e.g. corresponding to data obtained via user input 210 at decision block 1006, to user session management service 316A operating on remote front end server 300A at execution block 1010. Exemplary routine 1100, described below in reference to FIG. 11, provides an example of how remote front end server 300A may process such a new search data set.

At decision block 1012, if routine 1000 has obtained search results from user session management service 316A, routine 1000 may proceed to execution block 1014; otherwise routine 1000 may continue to wait for a response for user session management service 316A. For example, the search results may correspond to one or more review data set summaries related to the search data set, including associated normalized numerical rating values, review credibility rating values, and CPM rating values.

Routine 1000 may rank the review data set summaries obtained from user session management service 316A at execution block 1014. For example, routine 1000 may rank the review data set summaries by normalized numerical rating value, review credibility rating value, CPM rating value, date, user identifier, relevance, source, or the like.

Referring now to FIG. 10B, routine 1000 may render some or all of the ranked search results, e.g. via display 212, at execution block 1016.

At decision block 1018, if routine 1000 obtains a search result selection, e.g. via user input 210, corresponding to a particular review data set summary from the search results, routine 1000 may proceed to execution block 1022; otherwise routine 1000 may proceed to decision block 1020.

At decision block 1020, if a cancel request is obtained, e.g. via user input 210, then routine 1000 may proceed to return block 1099; otherwise routine 1000 may return to decision block 1018.

Routine 1000 may render a review data set summary, e.g. via display 212, at execution block 1022. For example, the review data set summary may include data corresponding to the review data set summary's descriptor set, user identifier, normalized numerical rating value, review credibility rating value, CPM rating value, date, and the like. Routine 1000 may also render an invitation for the user of client device 200A to selectively provide a support indication associated with the review data set.

At decision block 1024, if a support indication is obtained, e.g. via user input 210, routine 1000 may proceed to execution block 1026; otherwise routine 1000 may proceed to decision block 1028.

Routine 1000 may provide a support indication update request to user session management service 316A. The support indication update request may specific the user identifier and the review data set corresponding to the support indication obtained at decision block 1024.

At decision block 1028, if a cancel request is obtained, e.g. via user input 210, then routine 1000 may loop back to execution block 1016; otherwise routine 1000 may return to decision block 1024.

Routine 1000 may terminate, e.g. upon obtaining a cancel request via user input 210, at return block 1098 and/or return block 1099.

### Exemplary Search Request Routine

FIG. 11 illustrates an exemplary routine 1100, which may be implemented by user session management service 316A operating on remote front-end sever 300A. For example, an instantiation of client CPR/SN application 224 associated with an existing user session may provide one or more new search requests and the user-session management service may responsively execute instructions corresponding to routine 600.

Routine 1100 may obtain a new search request at execution block 1102.

Routine 1100 may generate search results at execution block 1104. The search results may include one or more review data sets.

At starting loop block 1106, routine 1100 may process each review data set in turn.

Routine 1100 may provide an internal rating generation request to internal rating generation service 316B operating on remote CPM/RC server 316B at execution block 1110. Exemplary routine 700, described above in reference to FIG. 7, provides an example of how remote CPM/RC server 300B may process such an internal rating generation request.

At decision block 1112, if routine 1100 obtains an internal rating generation response from internal rating generation service 316B, then routine 1100 may proceed to execution block 1114

Routine 1100 may update the review data set with the internal ratings obtained from internal rating generation service 316B at execution block 1114.

At ending loop block 1116, routine 1100 may loop back to starting loop block 1106 to process the next review data set, if any.

Routine 1100 may provide a search result response to the new search request, including the updated review data sets, at execution block 1118.

### CONCLUSION

Although specific embodiments have been illustrated and described herein, a variety of alternate and/or equivalent implementations may be substituted for the specific embodiments shown and described without departing from the scope of the present disclosure. This application is intended to cover any adaptations or variations of the embodiments discussed herein.

For example, internal rating generation service 316B may incorporate physiological data in the journal entries. As discussed above, in another aspect of at least one exemplary embodiment, client device 200 may include an optional physiological sensor 218 (or may interact with an external physiological sensor (not shown), e.g. through network interface 208). Client CPR/SN application 224 allow the user to selectively cause physiological data about the user (such as heart beat, body temperature, etc.) to be collected via physiological sensor 218 before, during, and after experiencing a cannabis-based product. This data may be associated with the experience and saved to the CPR/SN database 108 and becomes a series of experiences rich with data that the user may search or use as variables to match with other users or sources or strains.

1. (canceled)

2. A method of improving results provided by a recommendation system responsive to a search request relating to subjective user reviews, the method comprising:
parsing the search request to generate a search query corresponding to said search request, said search query including at least one search term value;
obtaining a set of search results responsive to said search query, said set of search results including a first review data set identifier associated with a first review data structure, said first review data structure including a first system user identifier and a first set of descriptors including at least one descriptor value;
determining a first normalized subjective rating value associated with said first review data structure;
determining a current first personal credibility rating value associated with said first system user identifier;
determining a total sum of current personal credibility rating values for each user identifier of a plurality of system user identifiers, said plurality of system user identifiers including said first system user identifier;
determining a current first review confidence score value associated with said first normalized subjective rating value;
determining a current first review meta-rating score value associated with said first set of descriptors;
determining a summation of a plurality of historical normalized subjective rating values and associated review confidence score values correlated to said first set of descriptors; and
providing a response to the search request, said response including said first system user identifier, said first set of descriptors, said first normalized subjective rating value, said current first review confidence score value, and said current first review meta-rating score value; and
wherein said current first review meta-rating score value is a function of said first normalized subjective rating value, said first review confidence score value, said current first personal credibility rating value, said total sum of current personal credibility rating values, and said summation of said plurality of historical normalized subjective rating values and associated review confidence score values correlated to said first set of descriptors.

3. The method of claim 2, wherein:
the search request includes a second system user identifier, said second system user identifier being associated with the search request;
the method further comprises:
obtaining a second review data structure, said second review data structure including said second system user identifier, and a second set of descriptors including at least one descriptor value,
comparing said second set of descriptors to said first set of descriptors,
determining a second normalized subjective rating value associated with said second review data structure, and
determining a user preference scaling factor value based on a comparison of said second set of descriptors to said first set of descriptors and a comparison of said second normalized subjective rating value to said first normalized subjective rating value; and
said current first review meta-rating score value is a function of said user preference scaling factor value.

4. The method of claim 2, wherein determining said current first personal credibility rating value associated with said first system user identifier comprises:
identifying a first set of other-system user identifiers, said first set of other-system user identifiers having each provided at least one attribute endorsement associated with said first system user identifier;
determining a number of attribute endorsements associated with said first system user identifier provided by each of said first set of other-system user identifiers;
identifying a second set of other-system user identifiers, said second set of other-system user identifiers having each provided at least one support indication to a content submission associated with said first system user identifier;
determining a number of support indications associated with said first system user identifier provided by each of said second set of other-system user identifiers;
identifying a third set of other-system user identifiers, said third set of other-system user identifiers having each followed said first system user identifier;
determining a number of followers of said first system user identifier;
recursively determining a current personal credibility rating value for each user identifier in said first set of other-system user identifiers, said second set of other-system user identifiers, and said third set of other-system user identifiers; and
determining said current first personal credibility rating value using:
said number of followers of said first system user identifier,
said number of attribute endorsements associated with said first system user identifier provided by each of said first set of other-system user identifiers, and
said personal credibility rating values determined for each of said first set of other-system user identifiers, said second set of other-system user identifiers, and said third set of other-system user identifiers.

5. The method of claim 4, wherein said first review data structure includes a fourth set of other-system user identifiers, said fourth set of other-system user identifiers having each provided a support indication to said first review data structure, and determining said current first review confidence score value associated with said first normalized subjective rating value comprises:
recursively determining a current personal credibility rating value for each user identifier in said fourth set of other-system user identifiers; and
determining said current first review confidence score value using said current first personal credibility rating value, said current personal credibility rating value for each user identifier in said fourth set of other-system user identifiers, and said total sum of current personal credibility rating values.

6. The method of claim 2, wherein said first review data structure includes said first normalized subjective rating value.

7. The method of claim 2, wherein determining said current first review meta-rating score value associated with said first set of descriptors comprises:
identifying a plurality of review data set identifiers, each review data set identifier of said plurality of review data set identifiers being associated with a corresponding review data structure including a set of associated descriptors having at least one descriptor value in common with said first set of descriptors; and a normalized subjective rating value;
determining a correlation factor between said first set of descriptors and said set of associated descriptors for each of said plurality of review data set identifiers; and
determining a review confidence score for each review data set identifier of said plurality of review data set identifiers.

8. The method of claim 7, wherein determining said correlation factor between said first set of descriptors and said set of associated descriptors for each of said plurality of review data set identifiers comprises determining a degree of commonality between said first set of descriptors and said set of associated descriptors and a temporal delta between said first review data structure and said corresponding review data structure.

9. The method of claim 2, wherein said set of search results includes a plurality of review data set identifiers in addition to said first review data set identifier, each of said plurality of review data set identifiers being associated with a corresponding review data structure including a corresponding system user identifier, and a corresponding set of descriptors including at least one descriptor value; and the method further comprises:
determining a current review confidence score value for each review set identifier of said plurality of review data set identifiers; and
determining a current review meta-rating score value associated with each review set identifier of said plurality of review data set identifiers.

10. The method of claim 9, further comprising ranking said set of search results by current review meta-rating score value.

11. The method of claim 9, further comprising ranking said set of search results by current review confidence score.

12. A system useful in facilitating consumable product review services with respect to subjective user experiences, the system comprising:
a data store containing at least:
user account data relating to a set of user accounts, said set of user accounts including a first user account and said user account data relating to said first user account including a first system user identifier; and
historical usage data relating to subjective user experiences associated with a category of consumable products including a plurality of review data sets; and
a server computer in data communication with said data store, said server computer having:
a computer processing unit;
a network interface in data communication with said computer processing unit; and
memory in data communication with said computer processing unit and containing executable instructions for causing said computer processing unit to perform a first method including:
parsing the search request to generate a search query corresponding to said search request, said search query including at least one search term value;
obtaining a set of search results responsive to said search query, said set of search results including a first review data set identifier associated with a first review data structure, said first review data structure including a first system user identifier and a first set of descriptors including at least one descriptor value;
determining a first normalized subjective rating value associated with said first review data structure;
determining a current first personal credibility rating value associated with said first system user identifier;
determining a total sum of current personal credibility rating values for each user identifier of a plurality of system user identifiers, said plurality of system user identifiers including said first system user identifier;
determining a current first review confidence score value associated with said first normalized subjective rating value;
determining a current first review meta-rating score value associated with said first set of descriptors;
determining a summation of a plurality of historical normalized subjective rating values and associated review confidence score values correlated to said first set of descriptors; and
providing a response to the search request, said response including said first system user identifier, said first set of descriptors, said first normalized subjective rating value, said current first review confidence score value, and said current first review meta-rating score value; and
wherein said current first review meta-rating score value is a function of said first normalized subjective rating value, said first review confidence score value, said current first personal credibility rating value, said total sum of current personal credibility rating values, and said summation of said plurality of historical normalized subjective rating values and associated review confidence score values correlated to said first set of descriptors.

13. The system of claim 12, wherein:
the search request includes a second system user identifier, said second system user identifier being associated with the search request;
the method further includes:
obtaining a second review data structure, said second review data structure including said second system user identifier, and a second set of descriptors including at least one descriptor value,
comparing said second set of descriptors to said first set of descriptors,
determining a second normalized subjective rating value associated with said second review data structure, and
determining a user preference scaling factor value based on a comparison of said second set of descriptors to said first set of descriptors and a comparison of said second normalized subjective rating value to said first normalized subjective rating value; and
said current first review meta-rating score value is a function of said user preference scaling factor value.

14. The system of claim 12, wherein determining said current first personal credibility rating value associated with said first system user identifier includes:
identifying a first set of other-system user identifiers, said first set of other-system user identifiers having each provided at least one attribute endorsement associated with said first system user identifier;
determining a number of attribute endorsements associated with said first system user identifier provided by each of said first set of other-system user identifiers;
identifying a second set of other-system user identifiers, said second set of other-system user identifiers having each provided at least one support indication to a content submission associated with said first system user identifier;
determining a number of support indications associated with said first system user identifier provided by each of said second set of other-system user identifiers;
identifying a third set of other-system user identifiers, said third set of other-system user identifiers having each followed said first system user identifier;
determining a number of followers of said first system user identifier;
recursively determining a current personal credibility rating value for each user identifier in said first set of other-system user identifiers, said second set of other-system user identifiers, and said third set of other-system user identifiers; and
determining said current first personal credibility rating value using:
said number of followers of said first system user identifier,
said number of attribute endorsements associated with said first system user identifier provided by each of said first set of other-system user identifiers, and
said personal credibility rating values determined for each of said first set of other-system user identifiers, said second set of other-system user identifiers, and said third set of other-system user identifiers.

15. The system of claim 14, wherein said first review data structure includes a fourth set of other-system user identifiers, said fourth set of other-system user identifiers having each provided a support indication to said first review data structure, and determining said current first review confidence score value associated with said first normalized subjective rating value includes:
recursively determining a current personal credibility rating value for each user identifier in said fourth set of other-system user identifiers; and
determining said current first review confidence score value using said current first personal credibility rating value, said current personal credibility rating value for each user identifier in said fourth set of other-system user identifiers, and said total sum of current personal credibility rating values.

16. The system of claim 12, wherein said first review data structure includes said first normalized subjective rating value.

17. The system of claim 12, wherein determining said current first review meta-rating score value associated with said first set of descriptors includes:
identifying a plurality of review data set identifiers, each review data set identifier of said plurality of review data set identifiers being associated with a corresponding review data structure including a set of associated descriptors having at least one descriptor value in common with said first set of descriptors; and a normalized subjective rating value;
determining a correlation factor between said first set of descriptors and said set of associated descriptors for each of said plurality of review data set identifiers; and
determining a review confidence score for each review data set identifier of said plurality of review data set identifiers.

18. The system of claim 17, wherein determining said correlation factor between said first set of descriptors and said set of associated descriptors for each of said plurality of review data set identifiers comprises determining a degree of commonality between said first set of descriptors and said set of associated descriptors and a temporal delta between said first review data structure and said corresponding review data structure.

19. The system of claim 12, wherein said set of search results includes a plurality of review data set identifiers in addition to said first review data set identifier, each of said plurality of review data set identifiers being associated with a corresponding review data structure including a corresponding system user identifier, and a corresponding set of descriptors including at least one descriptor value; and the method further includes:
determining a current review confidence score value for each review set identifier of said plurality of review data set identifiers; and
determining a current review meta-rating score value associated with each review set identifier of said plurality of review data set identifiers.

20. The system of claim 12, wherein said method also includes ranking said set of search results by current review meta-rating score value.

21. The system of claim 12, wherein said method also includes ranking said set of search results by current review confidence score.
